(19) United States
(12) Patent Application Publication
(10) Pub. No.: US 2014/0346820 A1
(43) Pub. Date: Nov. 27, 2014

(54) SEAT AND ITS USE

(71) Applicant: SYMPATEX TECHNOLOGIES GMBH, Unterföhring (DE)

(72) Inventors: Stefan Brandt, Haar (DE); Mhamed Mouhassin, Munchen (DE)

(73) Assignee: SYMPATEX TECHNOLOGIES GMBH, Unterföhring (DE)

(21) Appl. No.: 14/357,639

(22) PCT Filed: Nov. 12, 2012
(86) PCT No.: PCT/EP2012/072363

§ 371 Date: May 12, 2014

(30) Foreign Application Priority Data
Nov. 11, 2011 (EP) 11188880.6

(51) Int. Cl. B60N 2/70; B32B 9/02; B32B 5/02; B60N 2/56; B32B 5/26

(52) U.S. Cl. CPC B60N 2/70; B60N 2/5628; B32B 5/26; B32B 5/022; B32B 5/026; B32B 9/025; B32B 2250/04; B32B 2250/05; B32B 2262/0276; B32B 2305/026; B32B 2307/7242; B32B 2317/08; B32B 2367/00; B32B 2605/003; B32B 2601/00
USPC 297/180.13; 297/452.1; 297/180.1

(57) ABSTRACT

A seat has a sitting surface and a back surface completely covered with an arrangement including first, second, and third layers. The first layer is formed of a seat material or leather and has a first side facing a user and a second side facing away from the user. The second side of the first layer is arranged on the second layer. The second layer has a third side facing the first layer and a fourth side facing away from the first layer. The second layer has an absorber to absorb moisture with a first component layer facing the first layer and having a first hydrophilicity and a second component layer having a second hydrophilicity greater than the first hydrophilicity. The third layer has an air duct layer. The second component layer faces the third layer, and the fourth side is arranged on the third layer.

This application is a U.S. national stage application of PCT/EP2012/072363, and claims priority to EP 11188880.6 filed in Europe on Nov. 11, 2011. The entire disclosures of each of the prior applications are hereby incorporated by reference in their entirety.

### BACKGROUND

The present invention relates to a seat and its use.

German Application No. DE 2004 052 076 A1 describes a vehicle seat comprising a seat element with at least one central area and at least one peripheral area. The areas designated as central are those in which the body of a person of average build touches the vehicle seat (“body contact areas”). The at least one central area has an air-impermeable and water vapour-permeable seat cover and an underlying cushion element. An air-conducting spacer is arranged between the seat cover and the cushion element in order to direct a first air flow through the spacer in a direction parallel to the seat fabric. The at least one peripheral-area comprises an air-permeable peripheral-area seat cover, so that a second air flow can flow outwards through the seat cover. When moisture collects between the vehicle seat and the body of the person sitting on the seat, that is, in the body contact areas, it is drained away from the body via the water vapour-permeable seat cover and reaches the spacer. There the moisture is gathered by the first air flow running parallel to the seat cover and removed, by which drying and cooling in the body contact areas take place. In addition, the seat described in DE 10 2004 052 076 A1 has a second air flow combined with the first air flow. The second air flow flows out through the peripheral areas of the seat, by which an additional cooling effect is generated, of which the person is immediately aware. This second air flow can however lead to unpleasant draught sensations, which are all the more un-pleasantly perceived, the more sensitive the person using the seat is to draughts and the higher the ambient temperature is in the vehicle. To lessen or avoid such unpleasant draught sensations, DE 10 2004 052 076 A1 proposes to reduce, by using a suitable control device, or completely switch off the second air flow generating the draught. However, a person sensitive to draughts would also find a reduced second air flow unpleasant and detrimental to seating comfort. If the second air flow is turned off, the person suffers from the absence of the cooling effect, by which the seating comfort also suffers.

### SUMMARY

Therefore, it is the object of the present invention to provide a seat that overcomes the stated disadvantages and thereby provide a seat with increased seating comfort.

This object is achieved by a seat having a sitting surface and a back surface, wherein the sitting surface and the back surface are completely covered with an arrangement. The arrangement comprises first, second and third layers. The first layer is formed of a seat material or leather. The first layer has a first side facing a user of the seat and a second side facing away from the user of the seat. The second side of the first layer is arranged on the second layer. The second layer has a third side facing the first layer and a fourth side facing away from the first layer. The second layer further has an absorber arranged to absorb moisture with at least two component layers including a first component layer facing the first layer and having a first hydrophilicity, and a second component layer having a second hydrophilicity. The second hydrophilicity is greater than the first hydrophilicity. The third layer has an air duct layer. The second component layer of the second layer faces the third layer, and the fourth side of the second layer is arranged on the third layer.

Within the context of the preferred embodiments, the term “moisture” means preferably sweat and water vapour.

Because the sitting surface and back surface in the seat according to a preferred embodiment are completely covered with the arrangement comprising the first, second and third layers, there is no place on the seat, including the peripheral areas of the sitting and back surfaces, that has even a slight draught effect, meaning the person sitting on the seat receives increased sitting comfort.

In addition, a result of the arrangement of the layers completely covering the sitting and back surfaces is that the seat according to a preferred embodiment can remove moisture, preferably sweat and water vapour, through the entire sitting and back surfaces, including the peripheral areas of the sitting and back surfaces.

The removal of moisture, preferably of sweat and water vapour, is particularly efficient in the seat according to a preferred embodiment, because the absorber, comprising at least two component layers including the second layer, absorbs (absorptive effect) the moisture, preferably sweat and water vapour, through the seat material that the first layer comprises or through the preferably perforated leather that the first layer comprises, whereupon the moisture, preferably sweat and water vapour, is taken up by the air duct layer that the third layer comprises and is drained away from the seat.

The previously mentioned absorptive effect of the absorber comprising at least two component layers is achieved in that the first component layer (2a) of the absorber with a hydrophilicity (I), for example, and the second component layer (2b) of the absorber with a greater hydrophilicity (II), for example, in comparison to the first component layer (2a) can generate a hydrophilicity gradient and thus an absorptivity gradient. The gradient on transfer from component layer (2a) to component layer (2b) increases step-wise, by which moisture, preferably sweat and water vapour, can only flow in the direction of the side facing away from the first layer, that is, away from the user of the seat (a one-way effect). The first component layer of the absorber layer structure with the lowest hydrophilicity thereby works as a hydrophilic barrier layer for moisture, preferably for sweat and water vapour.

In a further embodiment of the seat, the absorber that the second layer comprises can contain a first component layer (2a) facing the first layer and having, for example, a hydrophilicity (I), a second component layer (2b) facing the third layer and having, for example, a hydrophilicity (II), and a third component layer (2c) facing the third layer and having, for example, a hydrophilicity (III), wherein the hydrophilicity (II) is greater than the hydrophilicity (I), and the hydrophilicity (III) is greater than the hydrophilicity (II).

In a further embodiment of the seat, the absorber that the second layer comprises can, in addition to the third component layer (2c), have a fourth component layer (2d) with, for example, a hydrophilicity (IV) facing the third layer, insofar as the component layers (2a) to (2d) fulfil the relation of hydrophilicity (IV)>hydrophilicity (III)>hydrophilicity (II)>hydrophilicity (I).

Within the context of a preferred embodiment, the hydrophilicity or absorption of the moisture, preferably sweat and water vapour, of the component layers that the absorber comprises may be quantified, according to DIN 53924 (1997/03), as the rising height after a specified number of observations, wherein the rising height of a component layer is greater when the hydrophilicity of this component layer is greater.

In a preferred embodiment of the seat with a dual-layer absorber that contains the component layers (2a) and (2b), the rising height of the component layer (2b) is, for example, preferably at least 30% higher than the rising height of the component layer (2a).

In a further preferred embodiment of the seat with a dual-layer absorber that contains the component layers (2a) and (2b), the rising height of the component layer (2b) is preferably, but not limited to, at least 30 mm after 30 seconds of observation time and preferably, but not limited to, at least 60 mm after 2 minutes of observation time.

In a further preferred embodiment of the seat with a dual-layer absorber, the component layers (2a) and (2b) form a dual-layer composite, wherein the composite (for example, a non-woven fabric) is preferably achieved by the component layer (2a) being joined to the component layer (2b) by, for example, water jet consolidation, consolidation on loop-forming machines, or solidification by needles.

According to a preferred embodiment, the sweat created in the body contact area therefore need not be first converted from the liquid state of aggregation to water vapour in the seat, as is the case for the vehicle seat described in German Application No. DE 10 2004 052 076 A1, in which the sweat that is created in the body contact area first must be converted to a water vapour state, so that it can be removed as water vapour to the air-conducting spacer through the membrane, which is permeable only to water vapour. Consequently, the sweat that is not converted into water vapour remains in the area between the body and seat fabric, whereupon sitting comfort is reduced.

By contrast, according to a preferred embodiment, the moisture created in the seat, preferably the sweat created in the body contact area, may be transported without the indirect conversion to vapour and thus immediately into the absorber, comprising at least two component layers, of the second layer, and is not perceived as unpleasant by the user of the seat, due to the one-way effect described previously. This means that the seat according to a preferred embodiment offers the person sitting on the seat a further increase in seating climate comfort, in addition to the already described draught sensations that have been completely avoided.

In the seat according to a preferred embodiment, the side of the first layer facing away from the user of the seat may be arranged on the second layer. In a preferred embodiment of the seat, the side of the first layer facing away from the user of the seat may be arranged on the second layer by means of, for example, bonding, welding, quilting, sewing or flame lamination, wherein the bonding can be carried out, for example, dot-wise or with an open-pore adhesive-bonded non-woven or with a thermoplastic breathable adhesive made of polyurethane, polyamide or polyester.

In the seat according to a preferred embodiment, the side of the second layer facing away from the first layer may be arranged on the third layer. In a preferred embodiment of the seat, the side of the second layer facing away from the first layer may be arranged on the third layer by means of, for example, bonding, welding, quilting, sewing or flame lamination, wherein the bonding can be carried out, for example, dot-wise or with an open-pore adhesive-bonded non-woven or with a thermoplastic breathable adhesive made of polyurethane, polyamide or polyester.

In a further preferred embodiment of the seat, a waterproof and water vapour-permeable membrane may be arranged between the second and third layer, which has a side facing the second layer and a side facing away from the second layer. For this, the term “waterproof membrane” means that the membrane allows no liquid, e.g. water, to pass through in a time period of, for example, 5 minutes under the measurement conditions of ISO 811 with a pressure of, for example, 10⁵ Pa. In addition, the term “water vapour-permeable membrane” means that the membrane has a water vapour flow resistance value, designated as the RET value, of preferably, but not limited to, <20 [m²·Pa/W], particularly preferably of, but not limited to, 5 to 15 [m²·Pa/W]. The RET value indicates the water vapour partial pressure difference in Pa that exists between the side of the membrane facing the second layer and the side of the membrane facing the third layer, divided by the evaporation heat flow in W per m² of the membrane. The RET value is determined by the Hohenstein skin model test, which is described in the standard test instruction no. BPI 1.4, dated September 1987, of the Bekleidungsphysiologischen Instituts e.V. Hohenstein (Hohenstein Clothing Physiology Institute, Germany).

In a further preferred embodiment of the seat, the side of the membrane facing the second layer may be arranged by means of, for example, bonding, welding or flame lamination, wherein the bonding can be carried out, for example, dot-wise or with an open-pore adhesive-bonded non-woven or with a thermoplastic breathable adhesive made of polyurethane, polyamide or polyester.

In a further preferred embodiment of the seat, the side of the membrane facing the third layer may be arranged by means of, for example, bonding, welding or flame lamination, wherein the bonding can be carried out, for example, dot-wise or with an open-pore adhesive-bonded non-woven or with a thermoplastic breathable adhesive made of polyurethane, polyamide or polyester.

In a further preferred embodiment of the seat, a porous membrane may be arranged between the second and third layer, which is made of expanded polytetrafluoroethylene for example, or a pore-free membrane, which is made of polyether ester, polyether amide, polyether urethane or polyurethane, for example.

Also in the preferred embodiment of the seat in which a waterproof and water vapour-permeable membrane is arranged between the second and third layer, the removal of moisture, preferably sweat and water vapour, is done at a high level because the absorber that the second layer comprises absorbs the moisture created, preferably the sweat and water vapour, from the body of the seat user and from the first layer and transports it to the membrane, which thereby very efficiently transports the moisture, preferably the sweat and water vapour, into the air duct layer that the third layer comprises.

In an embodiment of the seat, the first layer comprises a seat material. In a preferred embodiment of the seat, the seat material that the first layer comprises may be, for example, a woven fabric, a knitted fabric, a non-woven fabric, or a 3D outer material or a similar textile fabric, wherein the materials can be perforated or not perforated, and wherein the non-woven fabric contains, for example, microfibers, or, for example, is made of microfibers.

In a further preferred embodiment of the seat, the seat material that the first layer comprises may be made of synthetic fibers, for example, polyester, polyamide or polyacrylonitrile, or of natural fibers, for example, cotton; or of fibers of regenerated cellulose, e.g. of Cuprophan or Viscose, or of a mixture of at least two of these types of fibers.

In a further embodiment of the seat, the first layer comprises leather. In a preferred embodiment of the seat, the leather that the first layer comprises may be a breathable natural leather, for example, a breathable synthetic leather, a perforated natural leather, or a perforated synthetic leather.

As previously mentioned, the second layer of the seat according to a preferred embodiment comprises an absorber having at least two component layers with the previously described absorptivity for moisture, preferably for sweat and water vapour. The absorber can also be designated as a super-absorber, due to its high absorptivity for moisture, preferably for sweat and water vapour, expressed by a rising height that is at least 30 mm after 30 seconds of observation time, for example.

However, a polymer that can absorb many times its own weight in moisture, particularly water, wherein the polymer swells to a large degree and forms a hydrogel, is not encompassed by the term “absorber” or “super-absorber” within the context of the preferred embodiment.

In a preferred embodiment of the seat, the absorber comprising at least two component layers may be air impermeable. For this, the term “air impermeable” means that the absorber has an air permeability measured according to ISO 9237:1995-12 (D) of, for example, less than 50 [Litersₐᵢᵣ/(m²·s)], preferably of, but not limited to, less than 0.5 [Litersₐᵢᵣ/(m²·s)].

In a further preferred embodiment of the seat, a waterproof and water vapour-permeable membrane may be arranged between the second and third layers, wherein the membrane has an air permeability measured according to ISO 9237: 1995-12 (D) of, for example, less than 0.5 [Litersₐᵢᵣ/(m²·s)]. In this preferred embodiment, the absorber comprising at least two component layers can also be air permeable, i.e. have an air permeability, for example, greater than 50 [Litersₐᵢᵣ/(m²·s)].

In the preferred embodiment of the seat in which a waterproof and water vapour-permeable membrane is arranged between the second and third layers, an air-permeable and thus also water vapour-permeable protective layer can be arranged between the membrane and air duct layer, in order to protect the membrane from mechanical destruction by components of the air duct layer. The protective layer can be, for example, a knitted fabric or an absorber for moisture, preferably water.

According to a preferred embodiment, the air duct layer that the third layer of the seat comprises has a side facing the second layer and a side facing away from the second layer.

In a preferred embodiment of the seat, the air duct layer that the third layer comprises may have a seat foam on its side facing away from the second layer.

In a further preferred embodiment of the seat, either the first layer, the second layer, or the third layer may contain a heating device, e.g. in the form of a seat heater.

As previously mentioned, the third layer of the seat according to a preferred embodiment comprises an air duct layer.

In a preferred embodiment of the seat, the air duct layer that the third layer comprises may be a knitted spacer fabric, e.g. in the form of a warp knit fabric, a raschel fabric, a non-woven spacer fabric, a reticulated foam, or an air-permeable absorber of moisture, preferably for water and sweat.

In the preferred embodiment of the seat in which the air duct layer is a knitted spacer fabric in the form of a warp knit fabric or a raschel fabric, the warp knit fabric can be double-sided. The knitted fabrics can have spacer strips or webs. In addition, the spacer structure and/or the knitted fabrics can be manufactured with a right-right or right-left knitted structure. The spacer structure can be, for example, a woven, knitted or non-woven structure, which, for example, is made of natural fibers or of synthetic fibers, wherein the fibers can be, for example, monofilament or multifilament fibers. A person skilled in the art who understands the preferred embodiment can use, for example, a reticulated polyurethane ester foam or a reticulated polyurethane ether foam instead of the knitted spacer fabric.

In a further preferred embodiment of the seat, the third layer is connected to, for example, an air conditioning system, a vehicle ventilation system, or ventilation channels, wherein the ventilation channels are, for example, incorporated in the knitted spacer fabric that the third layer comprises, by which the moisture, preferably sweat and water vapour, that arrives in the third layer as previously described may be transported away even more efficiently out of the knitted spacer fabric that the third layer comprises. If the third layer is connected to a vehicle air conditioning system, a temperature that the passenger finds either pleasantly cooling or pleasantly temperate is achieved in the layer structure of the seat according to a preferred embodiment by means of the individually adjustable temperature of the air conditioning system.

In addition, this disclosure relates to the use of the seat in, for example, motor vehicles, aeroplanes, trains, buses, commercial vehicles, child car seats, prams and in vehicles with electric drive.

As previously mentioned, the absorber comprising at least two component layers can also be air permeable, if a waterproof and water vapour-permeable membrane is arranged between the second and third layers of the seat according to a preferred embodiment. In this preferred embodiment of the seat, the absorber that the second layer comprises is thus preferably an air-permeable, dual-layer composite, wherein the dual-layer composite has a first component layer (2a) facing the first layer and having a hydrophilicity (I), and has a second component layer (2b) facing the second layer and having a hydrophilicity (II), wherein the hydrophilicity (II) is greater than the hydrophilicity (I).

A dual-layer composite of this type is described in detail in the unpublished international application of the applicant, application number PCT/EP2012/09416, which claims priority to the European patent application of the applicant, application number 11183965.0 Important aspects for the seat according to preferred embodiments are elaborated in the following paragraphs.

The desired hydrophilicity and absorptivity gradient can basically be achieved in different ways. In addition to the use of different materials or material combinations with inherently different hydrophilicity, e.g. polyester/polyamide or polypropylene/polyamide, the gradient can also be set in that the fibers of the dual-layer composite have a different fineness and/or that large-capillary component layers exist in addition to fine-capillary layers. In addition, the finishing procedures known in the art are suitable for changing the hydrophilicity/hydrophobicity of textile materials to set the desired hydrophilicity and absorptivity gradient.

In a preferred embodiment, the air permeable dual-layer composite may contain, for example, at least one non-woven layer. More preferably, both component layers of the air-permeable dual-layer composite are made of non-woven layers, which are differentiated by their increasing hydrophilicity in the direction of the waterproof and water vapour-permeable membrane. This means the component layer of the dual-layer composite facing the waterproof and water vapour-permeable membrane can be, for example, a non-woven polyamide, and the component layer of the dual-layer composite facing away from the membrane can be a, for example, a non-woven polyester. The dual-layer composite can consist of the same or different materials (e.g. polyester or polyamide). Insofar as both component layers of the dual-layer composite consist of the same materials, these materials are differentiated, for example, in their fineness and/or their capillary action.

In a preferred embodiment, the dual-layer composite may be constructed so that the component layer of the dual-layer composite facing the waterproof and water vapour-permeable membrane is formed by, for example, a non-woven fabric made of finer fibers (e.g. nanofibers, microfibers or standard fibers), and the component layer of the dual-layer composite facing away from the membrane may be formed by, for example, a non-woven fabric made of coarser fibers in comparison to the component layer facing the membrane.

In this way the efficient and rapid transport of moisture in the direction of the waterproof and water vapour-permeable membrane is achieved in a simple and elegant manner.

In a further preferred embodiment, the dual-layer composite may contain, for example, polyester as one of its materials and may be constructed so that the component layer of the dual-layer composite facing the waterproof and water vapour-permeable membrane is formed by a non-woven fabric with a lower proportion of polyester, and the component layer of the dual-layer composite facing away from the membrane is formed by a non-woven fabric with a higher proportion of polyester.

Particularly preferably, the dual-layer composite contains, for example, polyamide as an additional material. The proportions of the materials polyester and polyamide in the component layers of the dual-layer composite can lie between 0 and 100%, depending on the desired hydrophilicity gradient.

### BRIEF DESCRIPTION OF THE DRAWINGS

FIG. 1 shows the functioning of a preferred embodiment of the seat.

FIG. 2 shows the functioning of another preferred embodiment of the seat.

FIG. 3 shows another view of the seat according to the preferred embodiment in FIG. 2.

FIG. 4 shows different hydrophilicity grades of individual layers or component layers according to a preferred embodiment of the seat.

### DETAILED DESCRIPTION OF THE EMBODIMENTS

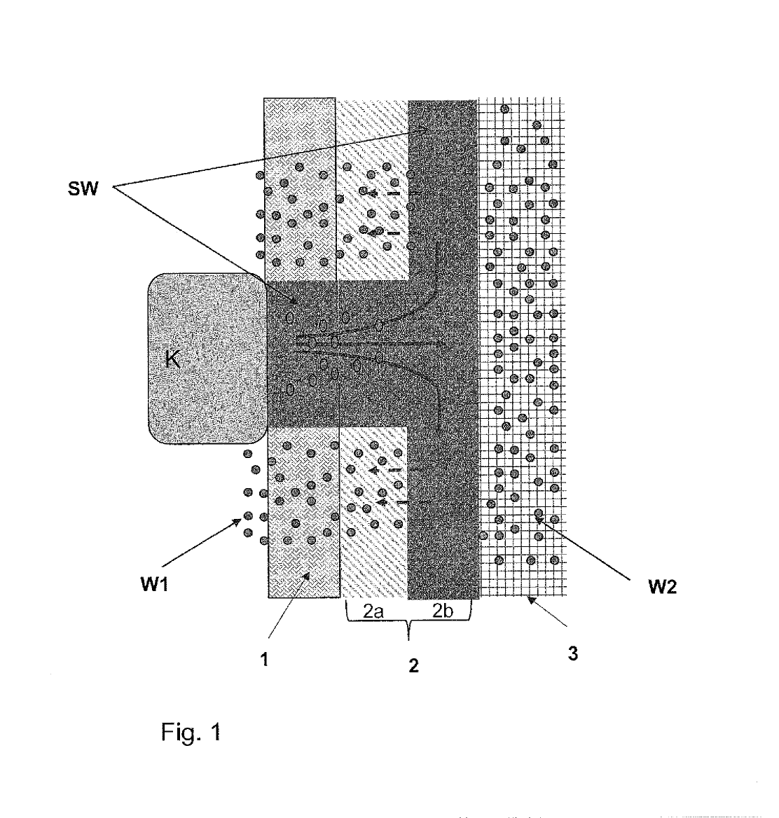

In the following, preferred embodiments are described in detail using the drawings. In FIG. 1, the functioning of a preferred embodiment of the seat is shown. In this preferred embodiment of the seat, the second layer 2 contains an absorber in the form of the already described dual-layer composite. The third layer 3 is an air duct layer in the form of a knitted spacer fabric. In the preferred embodiment of the seat shown in FIG. 1, the dual-layer composite is air impermeable.

FIG. 1 shows the previously described preferred embodiment of the seat and a body K in contact with the sitting and back surfaces of the first layer 1 of the seat.

In addition, FIG. 1 shows the second layer 2 with the absorber in the form of the already described air impermeable dual-layer composite, which has a first component layer 2a and a second component layer 2b, and also shows the third layer 3 in the form of a knitted spacer fabric of the seat.

Because the higher hydrophilicity (II) of the second component layer 2b of the absorber absorbs the sweat and water vapour SW into the spacer fabric, and the sweat and water vapour SW cannot flow back due to the lower hydrophilicity (I) of the first component layer 2a of the absorber, there is a preferred direction for the transport of sweat and water vapour SW, which is effectively expressed as a type of “one-way effect” and is symbolised by the arrows with solid lines in FIG. 1.

The second component layer 2b of the absorber, in turn, passes on the sweat and water vapour SW over a wide area. In doing so, the second component layer 2b of the absorber ensures, on the one hand, (i) that the sweat and water vapour SW are drained away from the body laterally and then exit the seat material or the breathable leather of the first layer 1 as water vapour W1 in the direction of the dashed arrows in FIG. 1 at points where there is no body contact, that is, from the peripheral areas of the sitting surface and the back surface; and ensures, on the other hand, (ii) that a correspondingly large volume of water vapour W2 flows into the knitted spacer fabric that the third layer 3 of the seat comprises, wherein the water vapour W2 is discharged.

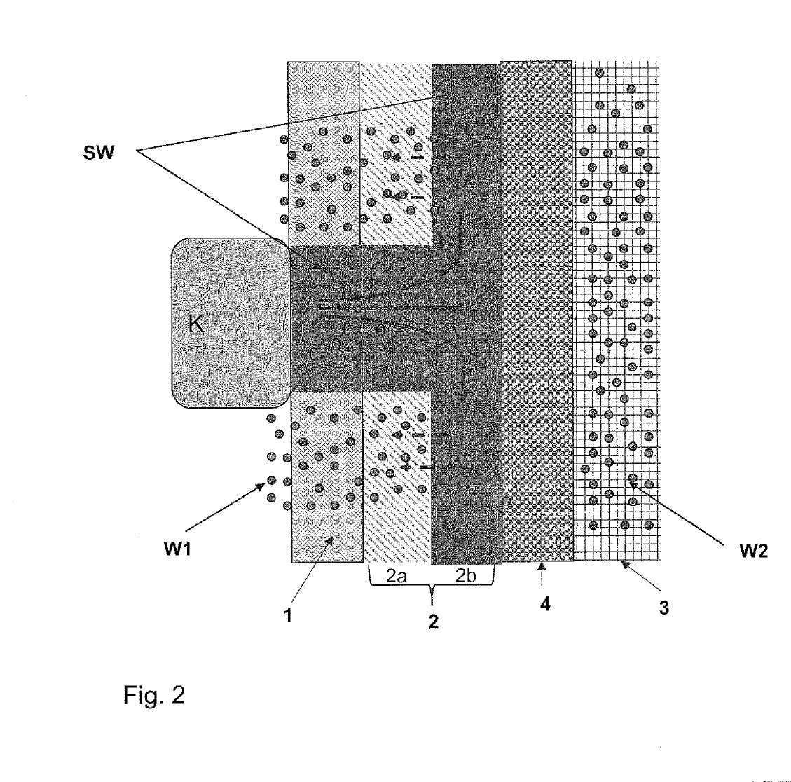

In FIG. 2, the functioning of another preferred embodiment of the seat is shown. In this preferred embodiment of the seat, the second layer 2 contains an absorber in the form of the already described dual-layer composite, a waterproof and water vapour-permeable membrane 4 is arranged between the second 2 and third 3 layers, and an air duct layer is provided in the form of a knitted spacer fabric as the third layer 3. Because the preferred embodiment of the seat shown in FIG. 2 contains a waterproof and water vapour-permeable membrane 4 arranged between the second 2 and third 3 layers, the dual-layer composite is air permeable.

FIG. 2 shows the previously described preferred embodiment of the seat and a body B in contact with the sitting and back surfaces of the first layer 1 of the seat.

In addition, FIG. 2 shows the second layer 2 with the absorber in the form of the already described air-permeable dual-layer composite, which has a first component layer 2a and a second component layer 2b, the waterproof and water vapour-permeable membrane 4 being arranged between the second 2 and third 3 layers and the third layer 3 being in the form of a knitted spacer fabric of the seat according to a preferred embodiment.

Because the higher hydrophilicity (II) of the second component layer 2b of the absorber causes the absorber to absorb sweat and water vapour SW in the direction of the membrane 4, and the sweat and water vapour SW cannot flow back due to the lower hydrophilicity (I) of the first component layer 2a of the absorber, there is a preferred direction for the transport of sweat and water vapour SW, which is effectively expressed as a type of “one-way effect” and is symbolised by the arrows with solid lines in FIG. 2.

The second component layer 2b of the absorber in turn passes on the sweat and water vapour SW over a wide area. In doing so, the second component layer 2b of the absorber ensures, on the one hand, (i) that the sweat and water vapour SW are drained away from the body laterally and then exit the seat material or the breathable leather of the first layer 1 as water vapour W1 in the direction of the dashed arrows in FIG. 2 at points where there is no body contact, that is, from the peripheral areas of the sitting surface and the back surface; and ensures, on the other hand, (ii) that the sweat and water vapour SW are passed on to the membrane 4 over a wide area, by which the membrane 4 is also activated over a wide area, so that the conversion of sweat into water vapour SW at the interface formed by the second component layer 2b of the absorber with the membrane 4 thus takes place quickly, and a correspondingly large volume of water vapour W2 flows into the knitted spacer fabric that the third layer 3 of the seat comprises, wherein the water vapour W2 is discharged.

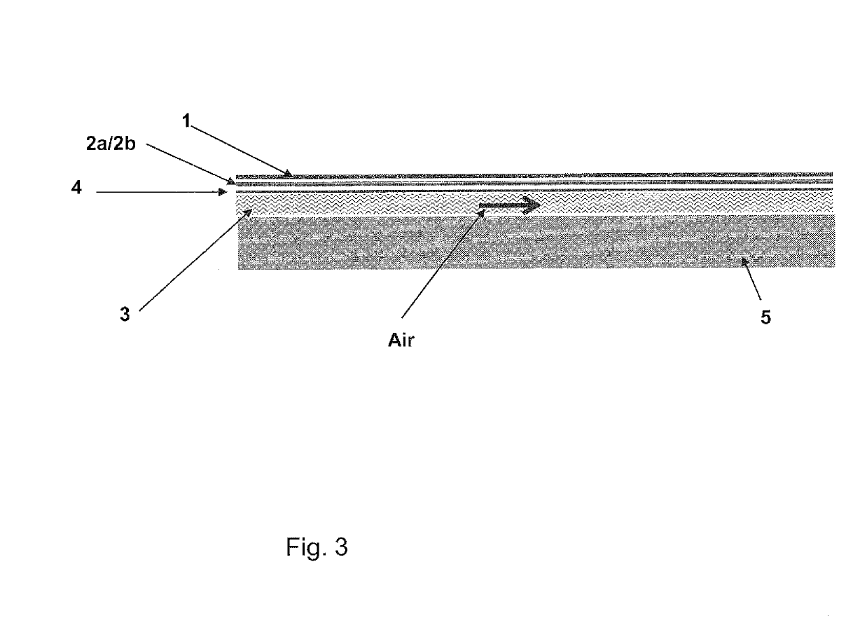

FIG. 3 shows the seat according to the preferred embodiment in FIG. 2 in another view. The numbers have the same meaning as in the previously described FIGS. 1 and 2.

In addition, FIG. 3 schematically shows a seat foam 5, which is arranged under layer 3 (containing the air duct layer). The removal that takes place through the air duct layer is represented by the thick arrow with the designation “air.” Advantageously, the air duct layer can also have a seat heater or be connected to such.

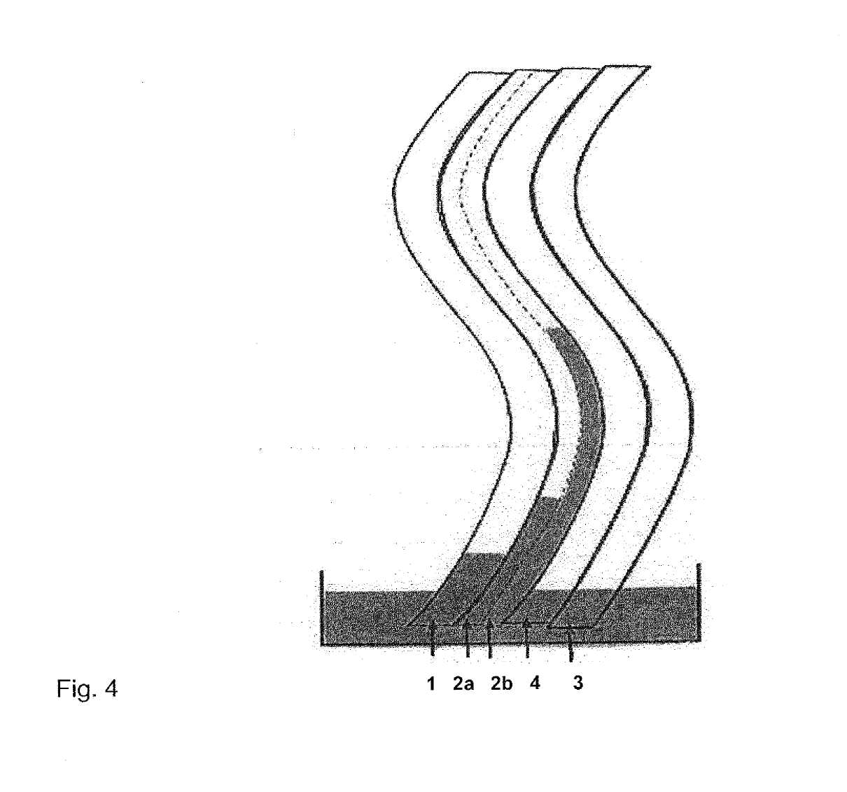

Lastly, FIG. 4 depicts the different hydrophilicity grades of the individual layers or component layers, measured according to the rising height method described above. The numbers here also have the same meaning as in FIGS. 1 and 2.

The rising height method shows how the absorber (or super-absorber) (consisting of component layers 2a and 2b) in layer 2 quickly absorbs water and widely distributes it in the direction of the membrane 4.

Exemplary embodiments of the present invention have been described above. It should be noted that the above exemplary embodiments are merely examples and the present invention is not limited to the detailed embodiments.

1. A seat having a sitting surface and a back surface, wherein the sitting surface and the back surface are completely covered with an arrangement, the arrangement comprising:
a first layer formed of a seat material or leather, the first layer having a first side facing a user of the seat and a second side facing away from the user of the seat;
a second layer on which the second side of the first layer is arranged, the second layer having a third side facing the first layer and a fourth side facing away from the first layer, the second layer further having an absorber arranged to absorb moisture, the absorber having at least two component layers including a first component layer facing the first layer and having a first hydrophilicity and a second component layer having a second hydrophilicity, wherein the second hydrophilicity is greater than the first hydrophilicity; and
a third layer having an air duct layer, the second component layer of the second layer facing the third layer, and the fourth side of the second layer being arranged on the third layer.

2. The seat according to claim 1, wherein
the second side of the first layer is arranged on the second layer by bonding, welding, quilting, sewing or flame lamination.

3. The seat according to claim 1, wherein
the fourth side of the second layer is arranged on the third layer by bonding, welding, quilting, sewing or flame lamination.

4. The seat according to claim 1, further comprising
a waterproof and water vapour-permeable membrane arranged between the second layer and the third layer.

5. The seat according to claim 4, wherein
the membrane is arranged on the second layer by bonding, welding or flame lamination.

6. The seat according to claim 4, wherein
the membrane is arranged on the third layer by bonding, welding or flame lamination.

7. The seat according to claim 4, wherein
the membrane is made of expanded polytetrafluoroethylene, polyether ester, polyether amide, polyether urethane or polyurethane.

8. The seat according to claim 1, wherein
the seat material of the first layer is a woven fabric, a knitted fabric, a non-woven fabric or a 3D outer material.

9. The seat according to claim 1, wherein
the seat material of the first layer is made of synthetic fibers, natural fibers, fibers of regenerated cellulose or of a mixture of at least two fiber types.

10. The seat according to claim 1, wherein
the leather of the first layer is a breathable natural leather, a breathable synthetic leather, a perforated natural leather or a perforated synthetic leather.

11. The seat according to claim 1, wherein
the absorber of the second layer is air impermeable.

12. The seat according to claim 1, wherein
one of the first layer, the second layer, and the third layer has a heating device.

13. The seat according to claim 1, wherein
the air duct layer of the third layer is a knitted spacer fabric, a non-woven spacer fabric, a reticulated foam, or an air-permeable absorber of moisture.

14. The seat according to claim 13, wherein
the third layer is connected to an air conditioning system, a vehicle ventilation system or ventilation channels, wherein the ventilation channels are incorporated into the knitted spacer fabric of the third layer.

15. The seat according to claim 1, wherein
the seat is used in a motor vehicle, an airplane, a train, a bus, a commercial vehicle, a child car seat, a pram, or an electric vehicle.

16. A seat comprising:
a first layer having a first user contact side and a second side facing away from the first user contact side;
a second layer having a third side facing the first layer and a fourth side facing away from the first layer, the second layer further having an absorber arranged to absorb moisture, the absorber having at least first and second component layers, the first component layer facing the first layer along the third side and having a first hydrophilicity, and the second component layer having a second hydrophilicity, wherein the second hydrophilicity is greater than the first hydrophilicity; and
a third layer having an air duct layer, the third layer being arranged to face the second component layer along the fourth side of the second layer.
